(19) United States
(12) Patent Application Publication
(10) Pub. No.: US 2012/0163004 A1
(43) Pub. Date: Jun. 28, 2012

(54) ANGLE ADJUSTABLE LAMP

(75) Inventor: Ching-Wen Hsia, Taoyuan (TW)

(73) Assignee: JENN FENG NEW ENERGY CO., LTD., Taoyuan (TW)

(21) Appl. No.: 12/975,916

(22) Filed: Dec. 22, 2010

(51) Int. Cl. F21V 19/02

(52) U.S. Cl. 362/418

(57) ABSTRACT

An angle adjustable lamp includes a base, at least one lamp holder, a support rod installed between the base and the lamp holder, and an angle adjusting mechanism disposed between the support rod and the lamp holder. The angle adjusting mechanism includes a plurality of cavities circularly arranged at one end of the support rod, at least one protrusion formed on the lamp holder and a bolt. The shape and location of the protrusion is corresponding to the cavities. The bolt pivots the support rod and the lamp holder, so the protrusion can be engaged with various cavities. When the lamp holder is turned, the location of the protrusion is changed so as to be engaged with another cavity, such that the illumination angle of the lamp is adjusted. The adjusted angle is fixed through tightening the bolt.

### BACKGROUND OF THE INVENTION

1. Field of the Invention

The present invention relates to a lamp, and more particular to a lamp capable of adjusting illumination angles of a lamp holder thereof.

2. The Prior Arts

For public safety, lamps are often installed in small alleys or dark corners. Some lamps have a fixed illumination angle, which provides illumination directing only to a fixed direction. Thus, the application of this type of lamps is limited. Therefore, manufacturers disclose several solutions to overcome the disadvantage of this type of conventional lamps.

As shown in FIG. 6, U.S. Pat. No. 5,649,761 disclosed a lamp activated by an infrared detector and capable of adjusting illumination angle. The lamp includes a base A, an infrared detector B and two lamp holders C installed on the base A. If the infrared detector B detects infrared emitted within a predetermined distance, the infrared detector B automatically actuates the lamp to provide illumination. Moreover, the lamp includes an illumination angle adjusting mechanism which has a support rod D installed between each lamp holder C and the base A. One end of the support rod D is connected with the base A by a pin D1 and the other end of the support rod D is connected with a first tooth ring D2. A second tooth ring D3 is installed on the lamp holder C. The first tooth ring D2 is engaged with the second tooth ring D3. A bolt E passes through the first tooth ring D2 and the second tooth ring D3 to securely engage the first tooth ring D2 with the second tooth ring D3 and fix the illumination angle of the lamp holder C. The bolt E has an adjusting knob E1 disposed at one end thereof. When the illumination angle of the lamp holder needs to be adjusted, the knob E1 of the bolt E is rotated to loose the engagement between the first tooth ring D2 and the second tooth ring D3 and a relative rotation space is defined between the first tooth ring D2 and the second tooth ring D3. After the depression/elevation angle of the lamp holder C is adjusted, the bolt E is rotated to tighten the engagement of the tooth rings for fixing the illumination angle.

However, the lamp mentioned above utilizes teeth of two tooth rings to engage with each other for adjusting the illumination angle. The teeth would be worn out in the long term, and therefore it is unable to fine tune and fix the illumination angle. This problems need to be solved.

### SUMMARY OF THE INVENTION

A primary objective of the present invention is to provide a lamp which can adjust illumination angles. The angle adjusting mechanism of the lamp is wear-resistant and has a long service life.

For achieving the aforementioned objective, an angle adjusting mechanism is provided between a lamp holder and a support rod. The angle adjusting mechanism includes a plurality of cavities circularly disposed at one end of the support rod, at least one protrusion formed on the lamp holder and a bolt for pivoting the support rod and the lamp holder. The shape and location of the protrusion is corresponding to one of the cavities. Thus, the protrusion can be engaged with various cavities, thereby adjusting illumination angles. When the lamp holder is turned, the protrusion is changed to be engaged with another cavity, such that the depression/elevation angle of the lamp holder is adjusted. The adjusted angle is fixed through tightening the bolt.

The present invention utilizes a mechanism of the protrusion sliding over and engaging with the cavities, so the lamp is provided with a function of multi-direction illumination for increasing the application range. On the other hand, the present invention is more wear-resistant and has a longer service life comparing to the conventional tooth-engaging structure.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view showing an angle adjustable lamp according to the present invention;

FIG. 2 is a perspective view showing a lamp holder and an angle adjusting mechanism according to the present invention;

FIG. 3 is an exploded view showing the angle adjusting mechanism according to the present invention;

FIG. 4 is a schematic cross sectional view showing the assembly of the angle adjusting mechanism according to the present invention;

FIG. 5 is a schematic view showing the operation of the angle adjusting mechanism of the lamp according to the present invention; and

FIG. 6 is a schematic view showing a conventional infrared detecting lamp;

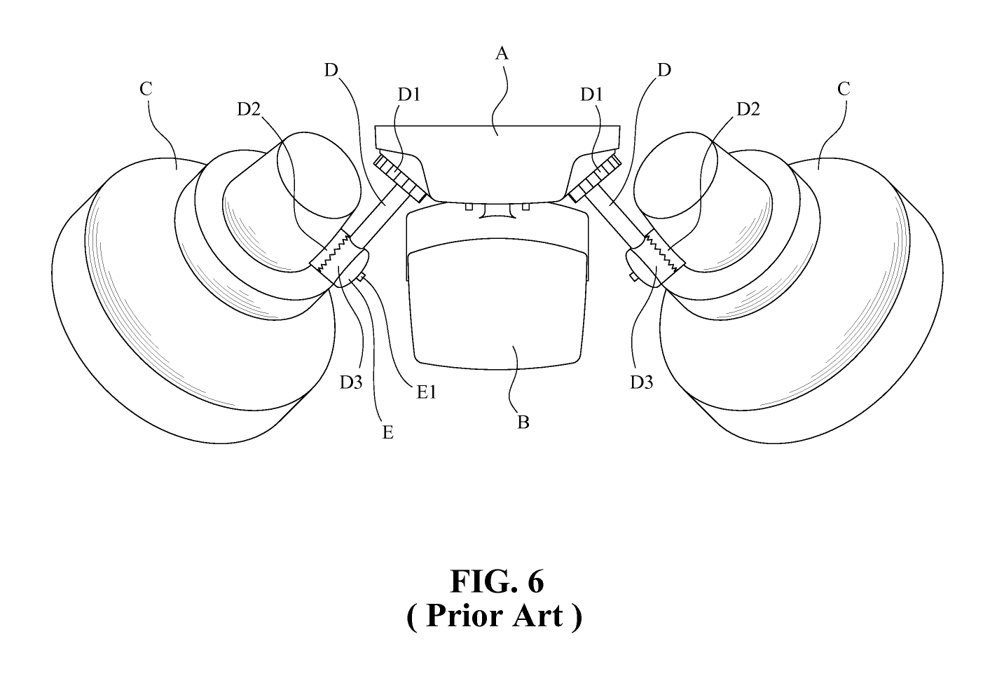

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

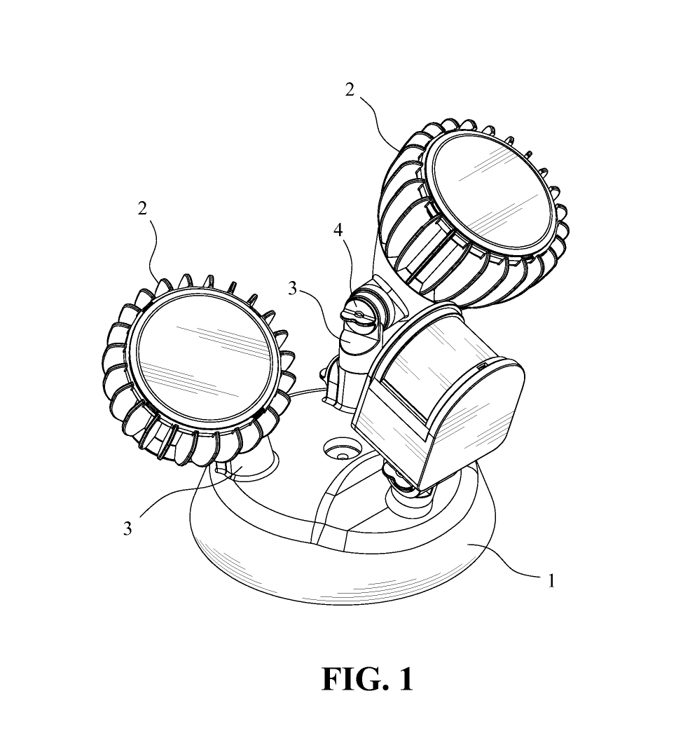

FIG. 1 is a schematic view showing an angle adjustable lamp according to the present invention. The angle adjustable lamp comprises a base 1, at least one lamp holder 2, a support rod 3 connecting each lamp holder 2 and the base 1, and an angle adjusting mechanism 4. The angle adjusting mechanism 4 is installed between the support rod 3 and the lamp holder 2 for adjusting the illumination angles, which is one of the features of the present invention.

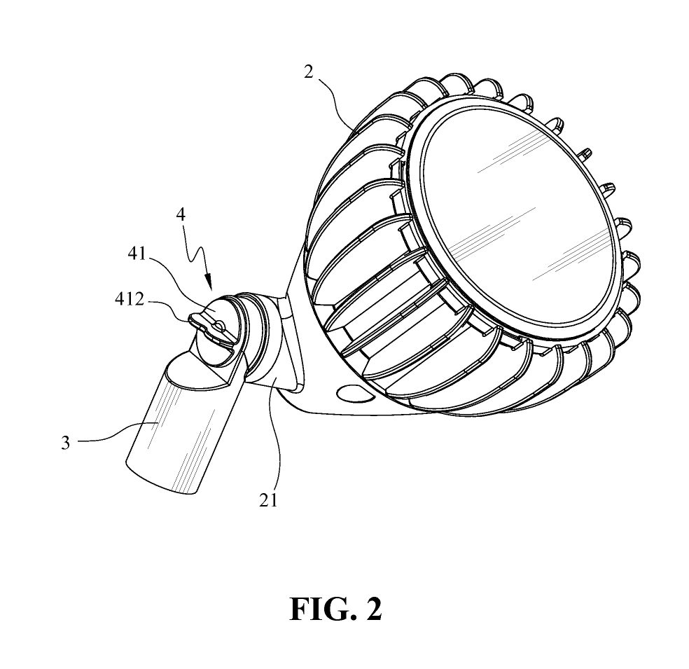

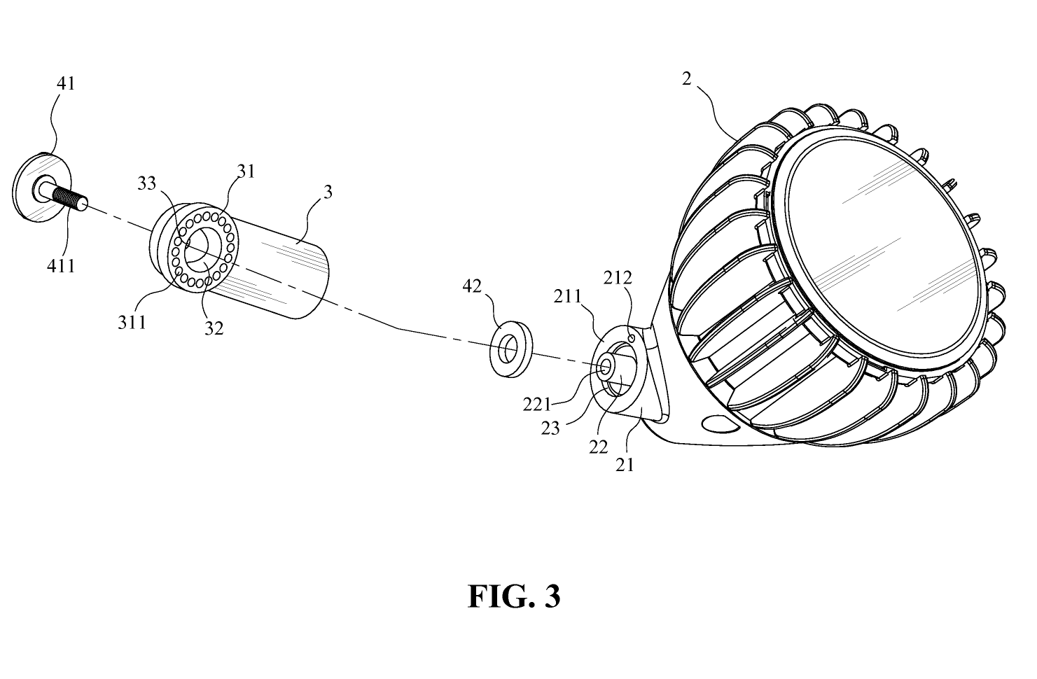

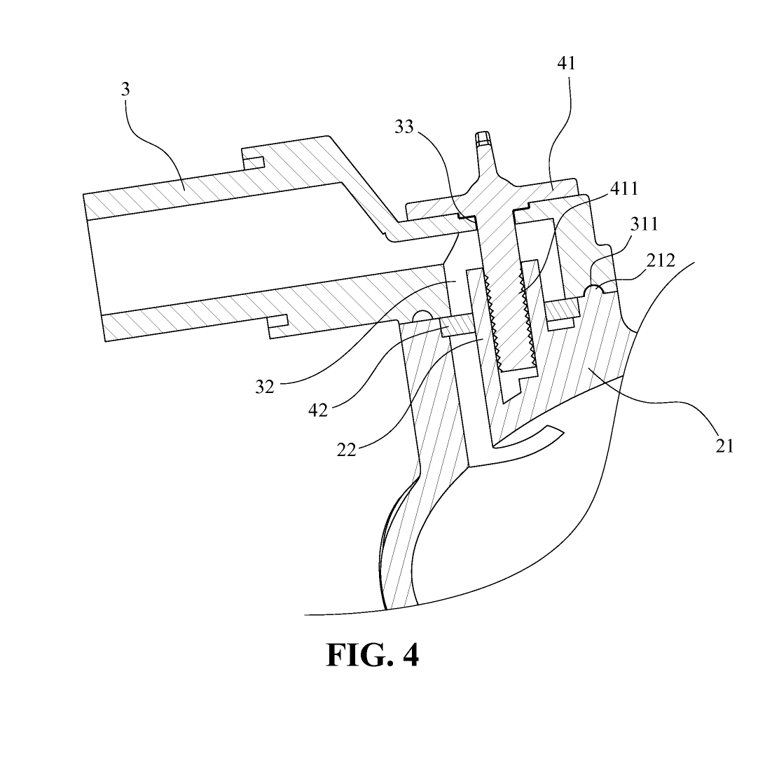

Referring to FIG. 2, the angle adjusting mechanism 4 includes a bolt 41 to pivot one end of the support rod 3 with a jointing portion 21 of the lamp holder 2. When loosening the bolt 41, it can adjust the depression/elevation angle of the lamp holder 2. On the other hand, when tightening the bolt 41, the depression/elevation angle of the lamp holder 2 is fixed. For forming a stepped angle adjustment, a fine-tune structure is provided between the support rod 3 and the jointing portion 21 of lamp holder 2. As shown in FIG. 3 and FIG. 4, the fine-tune structure includes a plurality of cavities 311 formed on an end surface 31 defined at one end of the support rod 3. The cavities 311 are preferable to be concave semi-sphere surfaces, and the cavities 311 are circularly distributed around the end surface 31. An end surface 211 of the jointing portion 21 has at least one protrusion 212 whose size and location are corresponding to the cavities 311. The shape of the protrusion 212 is also preferred to be in a semi-sphere shape. The bolt 41 passes through one end of the support rod 3 and the jointing portion 21 of the lamp holder 2, and the protrusion 212 is engaged with the one of the cavities 311, such that the support rod 3 is connected with the lamp holder 2.

Referring to FIG. 3 and FIG. 4, one end of the support rod 3 has a circular recess 32. The cavities 311 are disposed on the end surface 31 of the support rod 3 and circularly distributed around the recess 32 of the support rod 3. A through hole 33 is disposed at the support rod 3 and communicates with the circular recess 32. The jointing portion 21 of the lamp holder 2 includes a circular depression 23 disposed at a center thereof. A center of the depression 23 is formed with a connection column 22. The connection column 22 has a fastening hole 221 in the center. The fastening hole 221 is preferred to be a threaded hole. A washer 42 is sleeved on the connection column 22 and disposed at an opening of the circular depression 23. One end of the bolt 41 is equipped with a threaded rod 411 and the other end of the bolt 41 is formed with a bolt head 412. After the threaded rod 411 passes through the through hole 33 and the fastening hole 221, the threaded rod 411 is engaged with the inner threads of the fastening hole 221, such that the end surface 31 of the support rod 3 is engaged with the end surface 211 of the jointing portion 21.

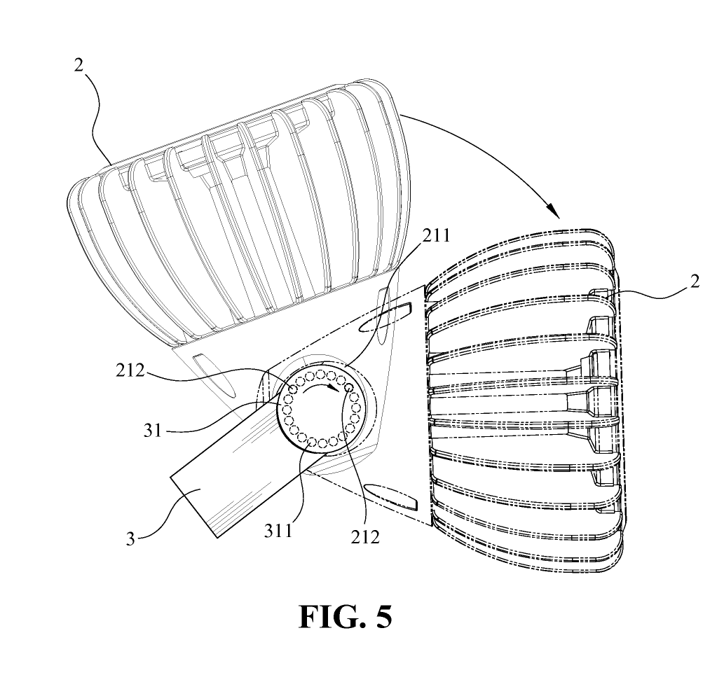

FIG. 5 is a schematic view illustrating operation of the angle adjusting mechanism of the angle adjustable lamp, wherein the bolt 41 is omitted for clarity. When the bolt head 412 is operated to tighten the support rod 3 and the jointing portion 21, the end surface 31 of the support rod 3 and the end surface 211 of the jointing portion 21 are firmly contacted with each other and the protrusion 212 is engaged with one of the cavities 311, so the lamp holder 2 is fixed at a certain angle. When the bolt 41 is turned loose, the end surface 31 is slightly away from the end surface 211, such that the jointing portion 21 can rotate with respect to the support rod 3. When rotating the lamp holder 2, the lamp holder 2 is rotated with respect to the support rod 3 and the protrusion 212 is sequentially slid through the other cavities 311. At this moment, the user can feel the stepped fine-tuning operation. When the lamp holder 2 is adjusted to another angle, the bolt 41 is tightened so the end surface 31 of the support rod 3 and the end surface 211 of the jointing portion 21 are firmly engaged again and the protrusion 212 is engaged with another cavity 311. Therefore, the illumination angle of the lamp holder 2 is adjusted.

The angle adjusting mechanism according to the present invention allows the lamp to provide multi-directional illuminations for increasing the illumination range thereof. The angle adjusting mechanism includes the semi-sphere protrusion and the semi-sphere cavities engaging with each other for precisely adjusting to the desired angle. On the other hand, comparing to the conventional tooth design, the present invention is more wearing-resistant and the service life is longer.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An angle adjustable lamp, comprising:
a base;
at least one lamp holder;
a support rod installed between the base and the lamp holder; and
an angle adjusting mechanism disposed between the support rod and the lamp holder;
wherein the angle adjusting mechanism includes a plurality of cavities disposed on an end of the support rod, at least one protrusion disposed on the lamp holder and a bolt pivotally connecting the support rod and the lamp holder; the cavities are circularly arranged on the end of the support rod, a shape and a location of the protrusion is corresponding to the cavities, such that the protrusion is engaged with one of the cavities; when the lamp holder is turned, the protrusion is rotated to engaged with another cavity, such that an illumination angle of the lamp is adjusted, and the adjusted angle is fixed through tightening the bolt.

2. The lamp according to claim 1, wherein the support rod has an end surface and the cavities are disposed on the end surface of the support rod; the lamp holder has an end surface and the protrusion is disposed on the end surface of the lamp holder.

3. The lamp according to claim 1, wherein the end of the support rod has a recess and a through hole communicating with the recess; the cavities are circularly distributed around the recess of the support rod; the bolt penetrates through the recess and the through hole.

4. The lamp according to claim 3, wherein the lamp holder comprises a jointing portion, a center of the jointing portion comprises a connection column corresponding to the recess of the support rod, the connection column has a fastening hole at a center thereof, the protrusion is disposed on an end surface of the jointing portion surrounding the connection column, the bolt passes through the through hole of the support rod and the fastening hole of the connection column to connect the lamp holder with the support rod, the protrusion is engaged with one of the cavities.

5. The lamp according to claim 4, wherein the jointing portion comprises a depression at the center thereof and the connection column is disposed at a center of the depression; a washer is sleeved on the connection column and disposed at an opening of the depression.

6. The lamp according to claim 1, wherein one end of the bolt comprises a threaded rod and another end of the bolt comprises a bolt head.

7. The lamp according to claim 4, wherein the fastening hole is a threaded hole.
